(19) United States
(12) Patent Application Publication
(10) Pub. No.: US 2024/0359190 A1
(43) Pub. Date: Oct. 31, 2024

(54) Methods for Pollucite Flotation, Plagioclase Flotation, and Quartz Purification

(71) Applicant: Tantalum Mining Corporation of Canada Ltd., Lac du Bonnet (CA)

(72) Inventors: Yongmei Jiao, Lac du Bonnet (CA); Claude Deveau, Lac du Bonnet (CA)

(21) Appl. No.: 18/630,541

(22) Filed: Apr. 9, 2024

Related U.S. Application Data
(60) Provisional application No. 63/498,996, filed on Apr. 28, 2023.

(51) Int. Cl. B03D 1/002; B03D 1/004; B03D 1/018; B03D 1/02; B03D 1/08

(52) U.S. Cl. CPC B03D 1/002; B03D 1/004; B03D 1/018; B03D 1/02; B03D 1/082; B03D 1/085; B03D 2201/007; B03D 2201/02; B03D 2201/04; B03D 2203/006; B03D 2203/025

(57) ABSTRACT

Described herein is a method for the recovery of two major valuable lithium minerals (amblygonite and spodumene), a cesium mineral (pollucite) and quartz. The method comprises a series of direct flotation processes combined with reverse flotation processes that were designed to recover these lithium and cesium concentrates.

### PRIOR APPLICATION INFORMATION

The instant application claims the benefit of US Provisional Patent Application U.S. Ser. No. 63/498,996, filed Apr. 28, 2023, entitled “METHODS FOR POLLUCITE FLOTATION, PLAGIOCLASE FLOTATION, AND QUARTZ PURIFICATION”, the entire contents of which are incorporated herein by reference for all purposes.

### BACKGROUND OF THE INVENTION

Cesium salt solution is used in oil & gas drilling processes, but cesium has become a rare resource. Tanco mine has the most abundant cesium supply in the world; however, it has become more and more difficult to obtain cesium from Tanco's orebody. On the other hand, pollucite ore often grew with lithium ore but the lithium ore has not been processed to recover pollucite and, as a result, considerable pollucite has been discharged as a tailing into the West Tailing Management Area (TMA). As will be understood by those of skill in the art, the material from West TMA was rejected from the mill (ground) and generally meets the size range of flotation without the need for much grinding.

In general, chemical engineering grade pollucite has to be higher than 5% Cs₂O. Due to the equipment limitations in our chemical plant at Tanco, lower grades of pollucite tend to generate a higher volume of chemical plant tailing, which results in lower cesium recovery. On the other hand, higher cesium grade pollucite will enhance cesium salt recovery and reduce production cost.

As a result of global mineral market changes, West TMA contains multiple valuable minerals, making mineral recovery research a priority. Specifically, the major minerals that comprise the West lithium tailing are amblygonite, spodumene, mica, feldspar, plagioclase, pollucite, and quartz. Originally, the mineral to be recovered was pollucite, but with increases in the price of lithium, lithium ores (including amblygonite and spodumene) became the recovery target.

Feeding low grade pollucite into the chemical plant is not only costly but also results in lower recovery of cesium. For example, even with 5-9% Cs₂O, the recovery is only ˜80%.

Methods for extracting pollucite from the West TMA material had been tested for quite some time without much success, nor was any effective method or reagent found in the literature. Specifically, the only effective reagent found was HF, with which pollucite was concentrated a little over 5% while recovering approximately 60% of the cesium. However, HF is toxic and extremely volatile.

### SUMMARY OF THE INVENTION

According to a first aspect of the invention, there is provided a method of floating pollucite comprising:
providing a quantity of mineral tailings comprising plagioclase, pollucite and quartz;
subjecting the quantity of mineral tailings to flotation conditions comprising TM2 and NH₄F at a ratio of about 1 part TM2 to about 2.3 parts NH₄F at a pH of about 2, wherein TM2 comprises about 1 part sodium sulfonate and about two parts tallowamineacetate, thereby separating the plagioclase from the pollucite and the quartz,
recovering the plagioclase;
subjecting the pollucite and quartz to flotation conditions comprising TM2 and NH₄F at a ratio of about 1 part TM2 to about 2.3 parts NH₄F at a pH of about 2.35 to about 2.8, thereby separating the pollucite from the quartz, and
recovering the pollucite.

According to another aspect of the invention, there is provided a method of recovering pollucite from mineral tailings comprising:
a) providing a quantity of mineral tailings comprising amblygonite, spodumene, mica, feldspar, plagioclase, pollucite and quartz;
b) subjecting the quantity of mineral tailings to flotation conditions comprising an amblygonite collector at a pH of about 9 to about 9.3, thereby separating the mineral tailings into separated amblygonite and mineral tailings comprising spodumene, mica, feldspar, plagioclase, pollucite and quartz;
c) recovering the amblygonite;
d) subjecting the mineral tailings comprising spodumene, mica, feldspar, plagioclase, pollucite and quartz to flotation conditions comprising a spodumene collector at a pH of about 9 to about 9.3, thereby separating the mineral tailings into separated spodumene and mineral tailings comprising mica, feldspar, plagioclase, pollucite and quartz;
e) recovering the floated spodumene;
f) subjecting the mineral tailings comprising mica, feldspar, plagioclase, pollucite and quartz to flotation conditions comprising a mica collector at a pH of about 2.26 to about 2.3, thereby separating the mineral tailings into separated mica and mineral tailings comprising feldspar, plagioclase, pollucite and quartz;
g) recovering the floated mica;
h) subjecting the mineral tailings comprising feldspar, plagioclase, pollucite and quartz to flotation conditions comprising a feldspar collector at a pH of about 2.1 to about 2.2, thereby separating the mineral tailings into separated feldspar and mineral tailings comprising plagioclase, pollucite and quartz;
i) recovering the floated feldspar;
j) subjecting the quantity of mineral tailings comprising plagioclase, pollucite and quartz to flotation conditions comprising TM2 and NH₄F at a ratio of about 1 part TM2 to about 2.3 parts NH₄F at a pH of about 2 wherein TM2 comprises about 1 part sodium sulfonate and about two parts tallowamineacetate, thereby separating the mineral tailings into separated plagioclase and mineral tailings comprising pollucite and quartz;
k) recovering the floated plagioclase;
l) subjecting the quantity of mineral tailings comprising pollucite and quartz to flotation conditions comprising TM2 and NH₄F at a ratio of about 1 part TM2 to about 2.3 parts NH₄F at a pH of about 2.35 to about 2.8, thereby separating the mineral tailings into separated pollucite and quartz; and
m) recovering the floated pollucite.

### BRIEF DESCRIPTION OF THE DRAWINGS

FIG. 1 is a bar graph shows mineral abundances at West TMA. The minerals to be recovered are spodumene, amblygonite, pollucite, and quartz. QEMScan work showed that quartz was the mineral with the highest abundance followed by pollucite and plagioclase.

FIG. 2 is a bar graph of data from 197 Drill Hole samples that shows that the average cesium grade was 0.53% Cs₂O at West TMA. As discussed herein, the Cs₂O has to be concentrated to feed the chemical plant.

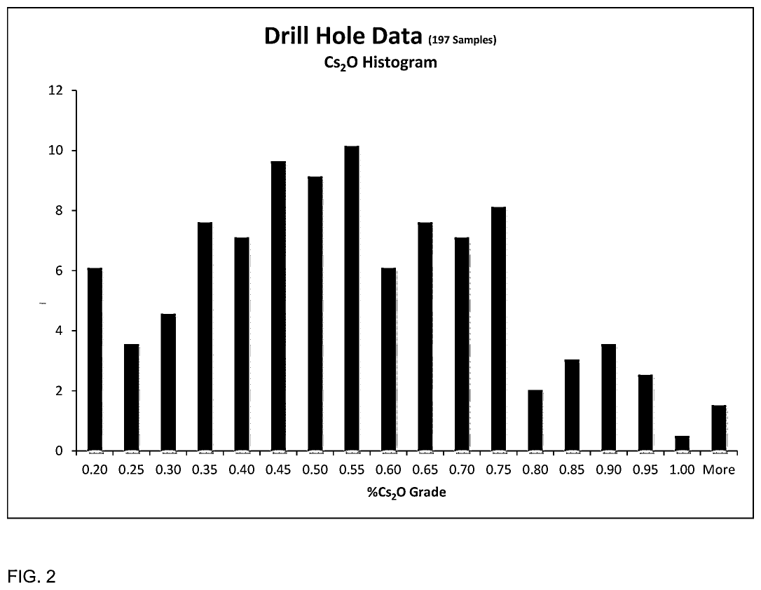

FIG. 3 is a flowchart of the West TMA Multiple Product Reverse Flotation Process.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Described herein is a method for the recovery of two major valuable lithium minerals (amblygonite and spodumene), a cesium mineral (pollucite) and quartz. The method comprises a series of direct flotation processes combined with reverse flotation processes that were designed to recover these lithium and cesium concentrates, as discussed below.

Based on the lithium concentrate production practices and 500+ tests on West TMA, a method of direct flotation combined with reverse flotation was designed to recover lithium and cesium concentrates, as discussed below.

According to an aspect of the invention, there is provided a method of floating pollucite comprising:
providing a quantity of mineral tailings comprising plagioclase, pollucite and quartz;
subjecting the quantity of mineral tailings to flotation conditions comprising TM2 and NH₄F at a ratio of about 1 part TM2 to about 2.3 parts NH₄F at a pH of about 2, or about 1.98 to about 2.02, wherein TM2 comprises about 1 part sodium sulfonate and about two parts tallowamineacetate, thereby separating the plagioclase from the pollucite and the quartz,
recovering the plagioclase;
subjecting the pollucite and quartz to flotation conditions comprising TM2 and NH₄F at a ratio of about 1 part TM2 to about 2.3 parts NH₄F at a pH of about 2.35 to about 2.8 or about 2.6 to about 2.8 or about 2.35 to about 2.45 or about 2.35 to about 2.6, thereby separating the pollucite from the quartz, and
recovering the pollucite.

The sodium sulfonate may be sodium sulfonate SNS 457 N™.

The tallowamineacetate may be Armac T™.

The plagioclase may be separated from the pollucite and the quartz by subjecting the mineral tailings to at least three separate flotation stages.

The pollucite may be separated from the quartz in at least 2 separate flotation stages.

According to another aspect of the invention, there is provided a method of recovering pollucite from mineral tailings comprising:
a) providing a quantity of mineral tailings comprising amblygonite, spodumene, mica, feldspar, plagioclase, pollucite and quartz;
b) subjecting the quantity of mineral tailings to flotation conditions comprising an amblygonite collector at a pH of about 9 to about 9.3, thereby separating the mineral tailings into separated amblygonite and mineral tailings comprising spodumene, mica, feldspar, plagioclase, pollucite and quartz;
c) recovering the amblygonite;
d) subjecting the mineral tailings comprising spodumene, mica, feldspar, plagioclase, pollucite and quartz to flotation conditions comprising a spodumene collector at a pH of about 9 to about 9.3, thereby separating the mineral tailings into separated spodumene and mineral tailings comprising mica, feldspar, plagioclase, pollucite and quartz;
e) recovering the floated spodumene;
f) subjecting the mineral tailings comprising mica, feldspar, plagioclase, pollucite and quartz to flotation conditions comprising a mica collector at a pH of about 2.26 to about 2.3 or about 2.3, thereby separating the mineral tailings into separated mica and mineral tailings comprising feldspar, plagioclase, pollucite and quartz;
g) recovering the floated mica;
h) subjecting the mineral tailings comprising feldspar, plagioclase, pollucite and quartz to flotation conditions comprising a feldspar collector at a pH of about 2.1 to about 2.2, or about 2.13 to about 2.17, thereby separating the mineral tailings into separated feldspar and mineral tailings comprising plagioclase, pollucite and quartz;
i) recovering the floated feldspar
j) subjecting the quantity of mineral tailings comprising plagioclase, pollucite and quartz to flotation conditions comprising TM2 and NH₄F at a ratio of about 1 part TM2 to about 2.3 parts NH₄F at a pH of about 2, wherein TM2 comprises about 1 part sodium sulfonate and about two parts tallowamineacetate, thereby separating the mineral tailings into separated plagioclase and mineral tailings comprising pollucite and quartz;
k) recovering the floated plagioclase;
l) subjecting the quantity of mineral tailings comprising pollucite and quartz to flotation conditions comprising TM2 and NH₄F at a ratio of about 1 part TM2 to about 2.3 parts NH₄F at a pH of about 2.4 to about 2.8 or about 2.6 to about 2.8, thereby separating the mineral tailings into separated pollucite and quartz; and
m) recovering the floated pollucite.

The amblygonite collector may comprise any amblygonite collector known in the art, for example, (1) a mixture of about 2 parts Aristonate® M and about 5 parts Aero® 727 Promoter; (2) Talon A150™ or (3) Polyfloat FA27™.

Aristonate M is a medium molecular weight, low foam oil soluble sodium alkyl aryl sulfonate; Aero® 727 Promoter is a mixture of fatty acids, sulfonated compounds and glycol ethers.

In some embodiments, an amblygonite frother is added with the amblygonite collector. The amblygonite frother may be any suitable amblygonite frother known in the art, for example, POLYFROTH® W31.

POLYFROTH® W31 is a (2-methoxymethylethoxy) propanol mixture.

The spodumene collector may be any suitable spodumene collector known in the art, for example, a mixture of Aristonate® M/Aero® 727 Promoter as outlined above or a different spodumene collector such as for example, Talon A150 or Polyfloat FA27, as outlined above.

A spodumene frother may be added with the spodumene collector. The spodumene frother may be any suitable spodumene frother known in the art, for example, POLYFROTH® W31.

In some embodiments, between steps (e) and (f), the mineral tailings are decanted to remove the basic solution and repulped in an acidic solution.

The mica collector may comprise any suitable mica collector known in the art, for example, a mixture comprising about 3 parts Duomeen TDO®, about 2.5 parts Armac T™ and about 0.5 parts Armeen CQ™.

Duomeen TDO® is a mixture of amines, N-C16-C18-alkyl-(even numbered, C18 unsaturated) propane-1,3-diaminium di[(9Z)-octadec-9-enoate].

Armeen C™ is made of cocoamine.

The feldspar collector may be any suitable feldspar collector known in the art, for example, a mixture comprising about 3 parts Duomeen TDO®, about 2.5 parts Armac T™ and about 0.5 parts Armeen C™ In some embodiments, between steps (a) and (b), the mineral tailings are subjected to an acidic wash and a basic wash.

In some embodiments, between steps (a) and (b), the mineral tailings are subjected to an acidic wash at a pH of about 2 and a basic wash at a pH of about 11.

The sodium sulfonate may be sodium sulfonate SNS 457 N™.

The tallowamineacetate may be Armac T™.

The plagioclase may be separated from the pollucite and the quartz by subjecting the mineral tailings to at least three separate flotation stages.

The pollucite may be separated from the quartz in at least 2 separate flotation stages.

As is known to those of skill in the art, tailing size is an important consideration for flotation processes. For example, minerals of a finer size are easier to suspend in solution and to attach to collector bubbles, which is necessary for flotation. As discussed herein, tests at different size ranges had been conducted, and have shown that finer size ranges (−212, or −300 μm) have higher recoveries than coarser ranges (−425 μm). Because obtaining finer material means grinding, which in turn means energy consumption and maintenance costs, materials are typically used at as coarse a grind as possible.

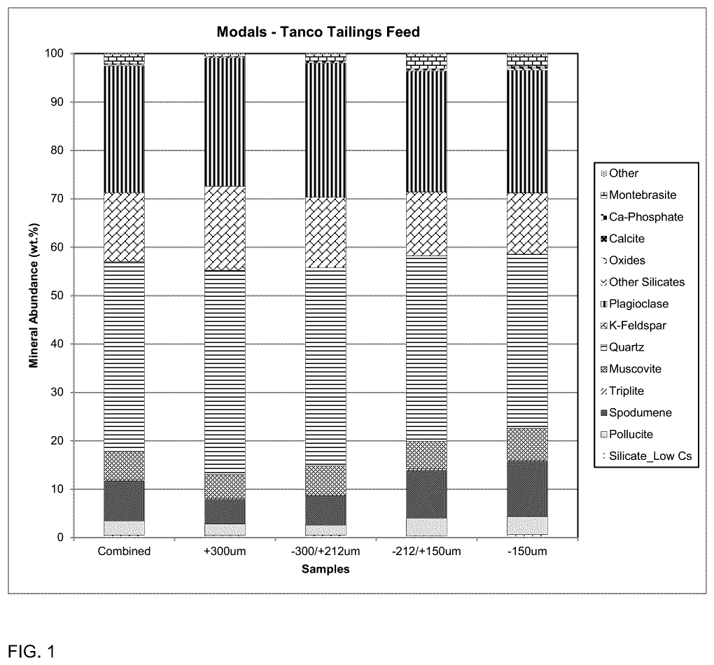

FIG. 1 shows the approximate percentages of different size ranges from the TWA material. As can be seen, the combined sample is about 3% pollucite, about 8% spodumene, about 4% muscovite, about 42% quartz, about 14% feldspar, about 27% plagioclase and about 2% montebrasite, with trace amounts of silicates, triplite, oxides, calcite, calcium phosphate and other material.

Separated by size, tailings larger than 300 μm are about 2% pollucite, about 7% spodumene, about 5% muscovite, about 40% quartz, about 18% feldspar, and about 27% plagioclase with trace amounts of montebrasite, silicates, triplite, oxides, calcite, calcium phosphate and other material.

As can be seen in FIG. 1, tailings from 300-212 μm are about 2% pollucite, about 7% spodumene, about 6% muscovite, about 40% quartz, about 15% feldspar, about 29% plagioclase and about 1% montebrasite, with trace amounts of silicates, triplite, oxides, calcite, calcium phosphate and other material.

Tailings from 212-150 μm are about 4% pollucite, about 11% spodumene, about 5% muscovite, about 39% quartz, about 12% feldspar, about 26% plagioclase and about 3% montebrasite, with trace amounts of silicates, triplite, oxides, calcite, calcium phosphate and other material.

Tailings smaller than 150 μm are about 4% pollucite, about 12% spodumene, about 6% muscovite, about 32% quartz, about 12% feldspar, about 27% plagioclase and about 2% montebrasite, with trace amounts of silicates, triplite, oxides, calcite, calcium phosphate and other material.

Plagioclase's chemical formula is Na(AlSi₃O₈), which is dominated by Na (11% Na₂O); feldspar's chemical formula is K(AlSi₃O₈), in which K₂O accounts for 12.6% and feldspar contains rubidium while plagioclase almost none. In each flotation, we examine 8 element assays to analyze the minerals: Li, Na, K, Rb, Cs, Fe, Si, and P.

As used herein, “about” or “approximately” in regards a number value refers to the base value plus or minus 10%. For example, “about 100” refers to “90-110 inclusive”.

Flotation is based on surface chemical properties of minerals. Minerals are generally wettable but not floatable unless hydrophobic collectors, which are composed by organic compounds that can generate air bubbles that can become attached to suitable minerals, are used.

The most complicated part of flotation is selection of reagents, which can be divided into three groups: collectors, frothers, and modifiers. Modifiers can be further subdivided into activators, depressants, pH modifiers, and dispersants. Although the general mechanism of flotation is understood, the specific surface reactions are not necessarily easy to predict or well understood. For example, it may be known that a reagent for a desired mineral must be a cationic collector, but a suitable cationic collector needs to not attract other negatively charged minerals.

Each collector has its own unique property (for example but by no means limited to electric charge and/or attractions of different organic groups) that may attract a particular mineral or a group of minerals, as discussed herein.

Tailings are generally composed of geologically co-existing minerals that share similar flotation properties, which can make separation of the individual minerals difficult. Specifically, when one desired mineral is being floated, other minerals may be entrained with the desired mineral.

It is however important to note that while these minerals may have similar flotation properties, they are after all different minerals. Consequently, the flotation kinetics of two or more co-existing minerals be different, allowing for separation thereof if suitable reagents are used.

For example, with the same collector, amblygonite is floated first, while spodumene takes longer to attach to the collector. As a result of this difference in their respective floatation kinetics with a suitable collector, amblygonite and spodumene can be separated.

The difference of minerals' flotation kinetics is another important property applied in flotation. As known by those of skill in the art, minerals will have different floatation kinetics if they have different points of zero charge (PZC, or the isoelectric point).

For example, for an oxide mineral, surface potential determining ions are hydrogen and hydroxide ions. Consequently, the surface potential of an oxide mineral is greatly influenced by the pH environment of the mineral. This means that at a certain pH, a mineral's surface charge is zero. The pH at which the surface charge is zero is critical for its surface electrical attraction potential. As known by those of skill in the art, at any pH greater than this value, the surface of the mineral will be negatively charged, whereas at any pH lower than this value, the surface of the mineral is positively charged. For example, when the surface of the mineral is negatively charged, the mineral can attach to a suitable, positively charged hydrophobic collector.

In general, the PZCs of TMA tailings are at low pHs. For example, spodumene has a PZC at pH=2 (Filippov et al. 2019); quartz has a PZC at 3 and iron oxide has a PZC at 6.7. Above the PZC, with increased pHs, the surface of all of these minerals for example may be negatively charged, but the rate and the extent of the charge change will depend on the respective PZCs and/or on their respective changing curve. This means that the degree of attraction to a particular collector may be different for two different minerals even though the two minerals could be floated by the same reagent, As will be appreciated by one of skill in the art, this means that control of pH and dosages of the reagents is, in some embodiments, important for the recovery of particular minerals.

As can be seen, because flotation is at a certain size range, and a flotation machine is about mixing and producing air to create physical motion to separate mineral, these physical properties need to be taken into account.

During and after the attachment between a mineral and a collector, which can be described in general as (a) mixing and conditioning and (b) flotation, a mixing tank and/or a flotation cell is used for separation and/or classification.

For example, a flotation cell can be used to generate uniform-sized bubbles, which in turn have a certain degree of surface attraction and floatability. During flotation, the floating or settling of a mineral particle greatly depends on the mechanical settling and the slurry parameters.

In summary, flotation results greatly rely on the reagents used and the flotation conditions (flotation cell, stirring/air speeds, temperature, and pH etc.). Previously, reagents and conditions applied to float spodumene, mica, and feldspar have been well developed; however, no practical method has been found to float pollucite.

As discussed in greater detail below, the combination of collectors, frothers, and modifiers used in the methods described below have been determined and/or demonstrated to achieve good selectivity and good recovery of the minerals to be floated.

Specifically, as discussed above, the most concentrated cesium developed from the West TMA was just over 5% Cs₂O which resulted in recovering approximately 60% of the cesium. This was achieved with HF, which, as discussed above, is a volatile/high toxicity reagent.

In the prior art processes, after lithium concentrate is removed as a product, mica and feldspar are removed as tails, and the major leftover minerals are pollucite, plagioclase, and quartz, which are not easy to separate and account for about 70% of the weight. As will be apparent to those of skill in the art, this is one of the reasons that pollucite can't be concentrated. Specifically, the difficulty lies in the similarity of mineralogy. However, through a large amount literature review, followed by “trial and error” tests, we have surprisingly developed a reagent mixture and optimized reaction conditions which resulted in a clean removal of plagioclase, a single stage pollucite product at a recovery of 65%, a grade of 16% of Cs₂O, and a relatively pure quartz product with low levels of other elements such as Li, K, Na, Rb, Fe, Cs, and P. Furthermore, the reagent mixture developed has no obvious safety impact to the mineral processing operation.

For example, as discussed herein, we have developed a non-HF & low toxicity reagent that can, for example, even concentrate lower grade (1.55%) pollucite up to over 16% Cs₂O with cesium recovery over 65%. That is, as discussed herein, the process concentrates for example pollucite by at least 10 fold, regardless of the starting concentration.

To compare the results of different reagents, we used a Denver D12 flotation cell to complete all the testing.

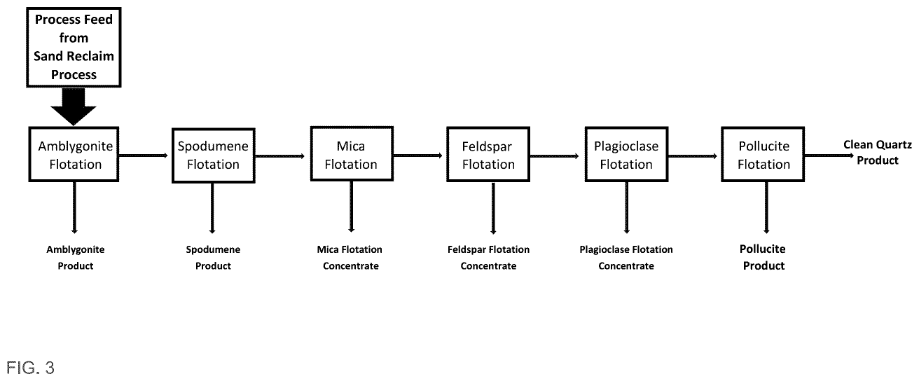

The newly established processing procedures are developed from over 500 past tests at Tanco. Currently, as shown in FIG. 3, West TMA processing contains 7 steps:
1. Screening and washing TMA sand
2. Amblygonite floatation and recovery
3. Spodumene flotation and recovery
4. Mica flotation and removal
5. Feldspar flotation and removal
6. Plagioclase flotation and removal
7. Pollucite flotation and recovery of both pollucite & quartz

For each step we have revised the experiment conditions based on best practices. From the feed to the concentrate at each step, we filtered, dried, and examined samples to assay for lithium, sodium, potassium, rubidium, iron, silicon, phosphorus, and cesium, from which we indirectly evaluated the loss or gain of minerals at each stage, as discussed below. This way, we gradually developed our current methods and reagents. Normally, we would have the following concentrates/tail examined:
Slime, from decant of a feed acidic/basic wash and a decant after spodumene flotation
Amblygonite, from the amblygonite floatation
Spodumene, from the spodumene flotation
Mica, from the one-stage mica flotation
Feldspar, from the 4-stage feldspar flotation
Plagioclase, from the 3-stage plagioclase flotation
Pollucite, from the 2-stage pollucite flotation
Quartz, the tail from the pollucite flotation

As discussed herein, in some embodiments, the feed is subjected to an acidic wash first, then subjected to a basic wash.

For each procedure, both methods (old/new) and reagents (old/new) are described in the following sections. Particular attention should be paid to the methods and regents in the 6^{th} and 7^{th} steps. Great consideration has been given to the entrainment of cesium during the application of reagents at earlier flotation stages such as amblygonite, spodumene, mica, feldspar, and plagioclase.

### 1. Screening and Washing of TMA Sand

Mineral size is related to the degree of mineral liberation. We tested multiple size ranges of West TMA sand (in μm): +425, −425-+212, and −212, which showed different characteristics. For the majority of the tests, we used a mineral size of −425 μm at a weight of 2.2 Kg. The flotation cell used is a 4 litre square Denver cell. We used an impeller rotation speed of 1450 rpm and a temperature range of 17 to 20° C.

We previously used NaOH at a pH of about 11 to condition the sand for 10 minutes and then decanted the slime to the sand line and used a magnetic rod to remove the magnetic material in the tailing.

Currently, we are using both diluted acid (H₂SO₄, pH≈2) and alkaline (NaOH, pH≈11) solution to wash the sieved feed for 10 minutes each, which resulted in better lithium and cesium recovery compared to the tests with only alkaline cleaning (conditioning).

Because tailings are being used, processing can be complicated by contaminates, such as, for example, dirt, old collectors, overfine gangue minerals, and the like. However, we used H₂SO₄ to clean the mineral surface followed by a basic wash. Surprisingly, we found that both recoveries and grades of cesium and lithium minerals increased. While not wishing to be bound to a particular theory or hypothesis, it may be that with both acid and basic washes, organic material was dissolved, and fine slimes were better dispersed, thereby improving removal thereof during the deslime process. That is, the acid wash may remove organic contaminants that would not have been dissolved by a basic wash alone. Furthermore, the additional acid wash may remove more of the fine materials that cover the mineral surface (slimes), thus resulting in a cleaner mineral surface for subsequent processing.

After each wash, the slime was decanted to a pail, together with the decant after spodumene flotation (in an alkaline environment), and a sample was filtered/dried as the slime sample for testing as discussed above.

In one embodiment of the invention, this stage comprises:
1) screen separation of the tailings to remove unwanted debris, such as organic material;
2) sizing the tailings, for example by a hydrosizer and/or a grinding mill, so that the tailings are of the desired size, for example, under 300 μm;
3) desliming the material as described above (deslime 1) to remove fine minerals and gangues from the surface of the tailings and to prepare the tailings for flotation;
4) scrubbing the surface of the particles, for example, using attrition scrubbers, in an acidic wash and a basic wash, as described above, which dissolves any chemical residues on the surface of the tailings;
5) removing any magnetic material, for example, with a magnetic separator; and
6) performing a second desliming (deslime 2) to remove dissolved residues.

Specifically, the initial screening step, using, for example, a 0.5 mm screen, separates organic material from the tailings.

As will be appreciated by one of skill in the art, the magnetic material may be for example residual steel from prior grinding operations. This material may be removed using a high intensity magnetic separator or a low intensity magnetic separator, for example, a magnetic separator at 2000 Gauss.

In some embodiments, a hydrosizer grinding mill set at 300 μm is used to reduce the mineral size to under 300 μm for flotation. In some embodiments, mineral tailings above 300 μm are sent to ball mills.

In some embodiments, the tailings are subjected to an acidic wash using low pH attrition scrubbers for about 10 minutes.

In some embodiments, the tailings are subjected to a basic wash using high pH attrition scrubbers for about 10 minutes.

The mixture may be deslimes using a cyclone or hydrocyclone device. As will be appreciated by those of skill in the art, this removes any residue dissolved from the tailings surface and also removes any fine particles.

### 2. Amblygonite Floatation and Recovery

At this stage, we followed our traditional method to recover amblygonite. Specifically, a reagent mix (Aristonate® M: Aero® 727 Promoter about 2 parts to about 5 parts by weight, about 121 g/t) is used for amblygonite flotation, with 3 minutes of conditioning and 1 minute collecting the floated concentrates. The conditioned pH is about 9 to about 9.3, which is the same as in spodumene flotation. In some embodiments, an amblygonite frother, for example, POLYFROTH® W31 is added. All the other conditions such as temperature and impeller rotation speed are the same throughout the test.

Amblygonite is easier to be floated than spodumene (with the same reagent). The dominant elements in amblygonite are phosphorus and lithium.

In some embodiments, the weight percentage of amblygonite is 12-19% and the major oxides are Li (3.3-4.3% assay percentage, 58-71% recovery percentage) and P (5.8-7.7% assay percentage, 82-94% recovery percentage).

### 3. Spodumene Flotation and Recovery

According to the flotation reaction kinetics, we used the same conditions, same reagents, and same method, described above, to recover spodumene after amblygonite flotation.

As can be seen, compared to amblygonite, spodumene has much less phosphorus but comparable amounts of lithium. The reagent mix used entrained less cesium during both amblygonite and spodumene floatation while still providing good lithium recovery, compared to other reagent mixes for lithium flotation.

In some embodiments, the weight percentage of spodumene is 10-16% and the major oxide is Li (1.0-2.2% assay percentage, 13-20% recovery percentage).

In some embodiments, the material is deslimed again after spodumene flotation, which serves two purposes: deslime and reduce the interaction of reagents. Initially, we were doing this step because Li concentrate production is under high pH (about 9 to about 9.3) while the rest of the flotations are conducted under acidic conditions. By desliming, reagent residues and slimes are both removed. As will be appreciated by one of skill in the art, in a full scaled production, if suitable, this may be achieved by other means, for example, with hydrocyclones or a thickener.

### 4. Mica Flotation and Removal

Mica flotation is carried out under acidic conditions, therefore, in this step, we decant the basic solution (part of the slime) using for example a hydrocyclone to remove unused reactant, after the spodumene flotation and repulp the tailings in an acidic environment (pH=about 2.26 to about 2.30) for 10 minutes. The flotation reagent recipe was used previously in West TMA recovery tests. This mixture was prepared by suspending reagents such as Duomeen TDO® (cationic alkyl diamine with a non polar fatty tail), Armac T™ (tallowamineacetates), and Armeen C™ (coco amine) (at about 3 to about 2.5 to about 0.5 by weight) in DI (Deionized) water for a few hours at about 50° C. until the mixture is uniform. The applied dosage is about 82 g/t. After a 3-minute conditioning with the mixture, a mica concentrate is floated. As discussed herein, using the same reagent, mica is easier to be floated than feldspar. Mica includes muscovite and lepidolite; the difference is that muscovite doesn't contain lithium whereas lepidolite does. Both lepidolite and feldspar are dominated by potassium and rubidium.

In some embodiments, the weight percentage of mica is 3-4% and the major oxides are Li (1.0-1.4% assay percentage, 4-5% recovery percentage), Rb (1.5-1.9% assay percentage, 12-21% recovery percentage) and K (5.8-7.3% assay percentage, 10-21% recovery percentage).

### 5. Feldspar Flotation and Removal

The 4-stage feldspar flotation process is identical to and uses the same reagent mix as mica flotation but with a lower dosage (about 68 g/t) for each stage and a pH of about 2.1 to about 2.2 or from about 2.13 to about 2.17 (compared to 2.3 from the 500+ tests). Like other stages, each stage is conditioned for 3 minutes with one minute of concentrate collecting.

The slightly reduced pH was proven to significantly reduce cesium entrainment at this stage while still providing a good recovery of feldspar, which is dominated by potassium and rubidium.

In some embodiments, this collector, TM3, comprises Duomeen TDO, Armac T and Armeen C at a about 3 to about 2.5 to about 0.5 ratio or a 3:2.5:0.5 ratio. With the dosage we used, it was found that after four stages of feldspar removal, there was no detectable amount of TM3 left, meaning that there is no concern of this collector having any influence on the subsequent steps.

This is significant, because in Tanco's previous tailing flotation tests, to avoid reagent interaction when floating pollucite, feldspar tails had to be heat treated at 500° C. to eliminate the collector being used previously. However, surprisingly, we can see that we don't have to do perform any active steps to eliminate TM3 from the reaction mixture. While not wishing to be bound to a particular theory or hypothesis, it is believed that because the minerals are thoroughly cleaned initially and subsequently are kept in a dynamic environment, the reagents do not have much time to adhere to the minerals. As will be appreciated by one of skill in the art, the selectivity of the reagents used in the method contributes greatly to the reduction of these adverse effects.

In some embodiments, the feldspar weight percentage is 11-19% and the major oxide is K (2.6-3.1% assay percentage, 14-36% recovery percentage).

### 6. Plagioclase Flotation and Removal

The reagent mix applied at this stage was originally designed to float pollucite and had achieved remarkable results: it was quite often seen that 98 to 100% cesium can be floated and separated from quartz tail (very clean too), but with a low grade. Experiments show that plagioclase is much harder to separate from pollucite than from quartz. While pursuing the best pH for pollucite flotation, we found that at a lower pH of about 2, for example, about 1.98 to about 2.02, instead of 2.2 or 2.3 applied previously, more plagioclase was floated than pollucite; however, under pH about 2, little material was floated. In the meantime, we found that the dosage of the reagent influenced the separation of plagioclase and pollucite as well, which will be explained below.

### The Reagent

There are two reagents used in plagioclase flotation: TM2, a mixture of sodium sulfonate SNS 457 N and Armac T at 1:2 ratio (by weight), which is mixed at 50° C. with DI water for a few hours until the mixture is uniform; and ammonium fluoride (NH₄F), an adjuster for mineral surface charge change. The TM2 reagent is based on a feldspar collector mix (Bulatovic 2014), in which sodium petroleum sulfonate (an anionic collector) was used to float albite. Specifically, sodium sulfonate SNS 457 N (Additiv Chemie Luers) is also an anionic collector and the overall mixture carries a positive charge due to the cationic nature of Armac T(tallowamineacetate, Nouryon) and the mixture ratio used. However, the pH used for the reaction is taught as being unfavorable for floating plagioclase and pollucite. It is important to note that if plagioclase and pollucite are floated together, they are very hard to separate, meaning that the grade of any pollucite recovered would be greatly reduced.

Furthermore, TM2 alone will not float pollucite and requires ammonia fluoride. Specifically, ammonia fluoride was introduced because we wanted to depress quartz, and this fluorine ion containing salt is non volatile (especially in water) under normal operating conditions. This property may be related to the following equation (under high temperatures) (Dyachenko 2022):

$${SiO}_{2} + 6 {NH}_{4} F \to {( {NH}_{4} )}_{2} {SiF}_{6} + 2 {H}_{2} O + 4 {NH}_{3}$$

However, under room temperature and relatively mild conditions, only low levels of surface reactions are expected. As with the other reactions described above, the dosage is a key parameter. Specifically, when we applied excessive dosage, pollucite was found depressed with quartz. However, when we tried using low dosage to depress quartz, we found that pollucite was floated.

We tested different pHs and examined cesium entrapment at each and finally decided that pH about 2 should be applied.

The It is important to note that the fluoride salt NH₄F is non volatile in water, especially at in a low pH environment. Because of its own acidic nature and the low dosage (g/t) used in this application, under the normal operating conditions, it is unlikely to generate HF when in flotation.

### The Dosage

As discussed above, we initially developed this reagent combination to float pollucite, but we found that under more acidic conditions and at a lower dosage than used for pollucite, plagioclase, which is dominated by sodium elements, was floated with little entrainment of pollucite.

There are 3 stages of flotation of plagioclase and the dosages are:

| Stages | TM2 (g/t) | NH₄F (g/t) |
|---|---|---|
| 1 | 73 | 169 |
| 2 | 66 | 152 |
| 3 | 59 | 137 |

Alternatively, 4 stages of flotation may be used wherein the dosages are:

| Stages | TM2 (g/t) | NH₄F (g/t) |
|---|---|---|
| 1 | 59 | 137 |
| 2 | 47 | 109 |
| 3 | 38 | 87 |
| 4 | 30 | 70 |

It is of note that while the dosages may change depending on the nature/properties of the tailings, TM2 and NH₄F are always proportional by weight: about 1 to about 2.3, or 1:2.3.

At each stage, slurry pH is controlled at about 2, with 3 minutes reagent condition time and one minute concentrate collecting time. At this pH, pollucite generally won't float. The dosage applied is based on the estimated dry weight at that stage, which is 0.43 of the dosage that can capture all the cesium at that dry weight. So, at the second stage, the estimated weight lost is 10%. Research found that when this ratio was applied, cesium has less opportunity to be floated, which might be attributed to the different specific gravity between plagioclase and pollucite (pollucite is heavier). According to Stokes' law, when particles are present at the same size range, the heavier ones, such as pollucite, have a greater settling velocity. With excessive collectors (higher dosages), pollucite is likely to be floated as well, and therefore lost at the plagioclase capture stage. That is, as discussed above, with the same estimated dosage, due to the different size distribution, cesium recovery is different with the same weight feed.

As will be appreciated by those of skill in the art, in some embodiments, at least 3 stages of plagioclase flotation are needed, depending on the tailings size and the distribution of minerals. Specifically, because a considerable weight percentage of the tailings is plagioclase, the advantage of using a large volume of water or less pulp density is to enhance the difference in weight between plagioclase and other, heavier minerals which leads to better settlement of the other minerals and therefore clearer separation of the plagioclase.

Furthermore, as plagioclase is removed at each flotation stage, the remaining plagioclase is less, so less TM2 and NH₄F are used to float just plagioclase without entrainment of pollucite (especially at a smaller size range). Specifically, as discussed herein, when larger volumes of collectors are used, the entrainment ratio of pollucite within the plagioclase increases as well. It is of note that for example by reducing pH to 2.2 from 2.3, the entrainment of cesium was reduced from about 10% to about 5% with no significant change in yield. In fact, reducing the pH to about 2.15 further reduced the entrainment by an average of 0.5%.

In some embodiments, the weight percentage of plagioclase is 14-24% and the major oxide is sodium (6.2-7.7% assay percentage, 22-53% recovery percentage).

### 7. Pollucite Flotation and Recovery of Both Pollucite & Quartz

Since at the pollucite flotation stage, the dry material is estimated at half of the feed, the maximum dosage applied are:

| Stages | TM2 (g/t) | NH₄F (g/t) |
|---|---|---|
| 1 | 118 | 273 |
| 2 | 118 | 273 |

For the feed under 212 μm, the dosage ensured the capture of all the cesium or pollucite and left only trace amounts or very low amounts of elements other than silicon in quartz. When floating pollucite, we found that pH about 2.35 to about 2.8, or about 2.4 to about 2.8, or about 2.6 to about 2.8 or 2.35 to about 2.45 or about 2.35 to about 2.6 is more favourable for pollucite flotation than at lower pHs.

While TM2 is a mixture generally used in mineral processing, NH₄F application is unusual, but after a general analysis, it seems that the impact is easily controllable. On the other hand, NH₄F application can be reduced because at the second stage of pollucite flotation, there is almost no cesium left to be collected.

Plagioclase is lighter than pollucite (specific gravities—2.62 and 2.79 respectively), which makes it possible to separate them using the same reagent at the same size range. However, as discussed above, dosage is an important parameter, as initially only enough bubbles are generated with the collectors to float plagioclase. That is, pollucite flotation also requires an increased dosage and longer conditioning time compared to plagioclase flotation.

Furthermore, pH is an important parameter as well, as demonstrated by the fact that pollucite could not be floated at a lower pH (2), while plagioclase could be floated. Furthermore, while pollucite has a higher PZC pH than plagioclase, both pollucite and plagioclase can be floated together in the presence of excessive collector dosing. As such, in order to separate these two minerals, the chemical and physical differences need to be exploited during flotation.

In some embodiments, the weight percentage of pollucite is 4-6% during the first stage flotation and 2-3% during the second stage flotation. The major oxide is Cs (4.1-12.4% assay percentage, 15-46% recovery percentage from the first stage flotation; 4.4-15.7% assay percentage, 21-47% recovery percentage from the second stage flotation).

In some embodiments, the remaining quartz is 20-25% of the weight percentage. The major oxide of the quartz is Si (96-100% assay percentage, 23-26% recovery percentage). As will be appreciated by those of skill in the art, quartz at this purity represents a potentially saleable product.

### General Comment on the Process

This process design provides a non-HF method to concentrate pollucite, and with the low dosage of reagent applied, there is little operational and/or environmental impact. In addition, the cesium assay on the concentrated pollucite showed doubled the number recovered by the HF flotation method.

The possibility of enriching pollucite not only provides a solution for the extraction of cesium from our West TMA, but also will help to enrich the low-grade ore which in turn will reduce the chemical plant processing cost.

Treating West TMA with this process, we have 4 products: amblygonite, spodumene, pollucite, and quartz, which broadens the economic potential. Furthermore, compared to traditional acid leaching methods to produce quartz, this flotation process is much more economical.

For example, with most of the plagioclase removed, pollucite could be enriched to a high cesium assay and be associated with only quartz, which doesn't consume acid; therefore, a purer cesium salt can be produced.

Moreover, in the current process design, for each step cesium entertainment is considered by adjusting pH, reagent type and dosage, therefore cesium concentration and recovery is maximized in this process.

While the preferred embodiments of the invention have been described above, it will be recognized and understood that various modifications may be made therein, and the appended claims are intended to cover all such modifications which may fall within the spirit and scope of the invention.

### REFERENCES

Bulatovic, Srdjan M. 2014. Handbook of Flotation Reagents: Chemistry, Theory and Practice: Volume 3: Flotation of Industrial Minerals. 1 st edition. Elsevier.
Dyachenko, Alexander. 2022. Ammonium Fluorides in Mineral Processing. IntechOpen.
Filippov, Lev, Saeed Farrokhpay, Lichau Lyo, and Inna Filippova. 2019. ‘Spodumene Flotation Mechanism’. Minerals 9(6):372. doi: 10.3390/min9060372.

1. A method of floating pollucite comprising:
providing a quantity of mineral tailings comprising plagioclase, pollucite and quartz;
subjecting the quantity of mineral tailings to flotation conditions comprising TM2 and NH₄F at a ratio of about 1 part TM2 to about 2.3 parts NH₄F at a pH of about 2, wherein TM2 comprises about 1 part sodium sulfonate and about two parts tallowamineacetate, thereby separating the plagioclase from the pollucite and the quartz,
recovering the plagioclase;
subjecting the pollucite and quartz to flotation conditions comprising TM2 and NH₄F at a ratio of about 1 part TM2 to about 2.3 parts NH₄F at a pH of about 2.35 to about 2.8, thereby separating the pollucite from the quartz, and
recovering the pollucite.

2. The method of claim 1 wherein the sodium sulfonate is sodium sulfonate SNS 457 N™.

3. The method of claim 1 wherein the tallowamineacetate is Armac T™.

4. The method according to claim 1 wherein the plagioclase is separated from the pollucite and the quartz by subjecting the mineral tailings to at least three separate flotation stages.

5. The method according to claim 1 wherein the pollucite is separated from the quartz in at least 2 separate flotation stages.

6. A method of recovering pollucite from mineral tailings comprising:
a) providing a quantity of mineral tailings comprising amblygonite, spodumene, mica, feldspar, plagioclase, pollucite and quartz;
b) subjecting the quantity of mineral tailings to flotation conditions comprising an amblygonite collector at a pH of about 9 to about 9.3, thereby separating the mineral tailings into separated amblygonite and mineral tailings comprising spodumene, mica, feldspar, plagioclase, pollucite and quartz;
c) recovering the amblygonite;
d) subjecting the mineral tailings comprising spodumene, mica, feldspar, plagioclase, pollucite and quartz to flotation conditions comprising a spodumene collector at a pH of about 9 to about 9.3, thereby separating the mineral tailings into separated spodumene and mineral tailings comprising mica, feldspar, plagioclase, pollucite and quartz;
e) recovering the floated spodumene;
f) subjecting the mineral tailings comprising mica, feldspar, plagioclase, pollucite and quartz to flotation conditions comprising a mica collector at a pH of about 2.26 to about 2.3, thereby separating the mineral tailings into separated mica and mineral tailings comprising feldspar, plagioclase, pollucite and quartz;
g) recovering the floated mica;
h) subjecting the mineral tailings comprising feldspar, plagioclase, pollucite and quartz to flotation conditions comprising a feldspar collector at a pH of about 2.1 to about 2.2, thereby separating the mineral tailings into separated feldspar and mineral tailings comprising plagioclase, pollucite and quartz;
i) recovering the floated feldspar
j) subjecting the quantity of mineral tailings comprising plagioclase, pollucite and quartz to flotation conditions comprising TM2 and NH₄F at a ratio of about 1 part TM2 to about 2.3 parts NH₄F at a pH of about 2, wherein TM2 comprises about 1 part sodium sulfonate and about two parts tallowamineacetate, thereby separating the mineral tailings into separated plagioclase and mineral tailings comprising pollucite and quartz;
k) recovering the floated plagioclase;
l) subjecting the quantity of mineral tailings comprising pollucite and quartz to flotation conditions comprising TM2 and NH₄F at a ratio of about 1 part TM2 to about 2.3 parts NH₄F at a pH of about 2.35 to about 2.8, thereby separating the mineral tailings into separated pollucite and quartz; and
m) recovering the floated pollucite.

7. The method according to claim 6 wherein the amblygonite collector is an Aristonate® M: Aero® 727 Promoter mixture at a ratio of about 2 to about 5 by weight.

8. The method according to claim 6 wherein an amblygonite frother is added with the amblygonite collector.

9. The method according to claim 8 wherein the amblygonite frother is POLYFROTH® W31.

10. The method according to claim 6 wherein the spodumene collector is an Aristonate® M: Aero® 727 Promoter mixture at a ratio of about 2 to about 5 by weight.

11. The method according to claim 6 wherein a spodumene frother is added with the spodumene collector.

12. The method according to claim 11 wherein the spodumene frother is POLYFROTH® W31.

13. The method according to claim 6 wherein, between steps (e) and (f), the mineral tailings are decanted to remove the basic solution and repulped in an acidic solution.

14. The method according to claim 6 wherein the mica collector comprises a mixture at a ratio of about 3 parts Duomeen TDO®, about 2.5 parts Armac T™ and about 0.5 parts Armeen C™.

15. The method according to claim 6 wherein the feldspar collector comprises a mixture at a ratio of about 3 parts Duomeen TDO®, about 2.5 parts Armac T™ and about 0.5 parts Armeen C™.

16. The method according to claim 6 wherein, between steps (a) and (b), the mineral tailings are subjected to an acidic wash followed by a basic wash.

17. The method according to claim 6 wherein, between steps (a) and (b), the mineral tailings are subjected to an acidic wash at a pH of about 2 followed by a basic wash at a pH of about 11.

18. The method according to claim 6 wherein the sodium sulfonate is sodium sulfonate SNS 457 N™.

19. The method according to claim 6 wherein the tallowamineacetate is Armac T™.

20. The method according to claim 6 wherein the plagioclase is separated from the pollucite and the quartz by subjecting the mineral tailings to at least three separate flotation stages.

21. The method according to claim 6 wherein the pollucite is separated from the quartz in at least 2 separate flotation stages.
